(19) United States
(12) Patent Application Publication
(10) Pub. No.: US 2008/0296123 A1
(43) Pub. Date: Dec. 4, 2008

(54) Powershift Transmission Clutch System With A Predetermined Running Clearance

(76) Inventors: Thomas Hung Vu, Cedar Falls, IA (US); Craig R. Elke, Coffeyville, KS (US); Joe R. Gray, Coffeyville, KS (US)

Correspondence Address: DEERE & COMPANY, ONE JOHN DEERE PLACE, MOLINE, IL, 61265, US

(21) Appl. No.: 11/754,457

(22) Filed: May 29, 2007

(51) Int. Cl. F16D 25/06

(52) U.S. Cl. 192/85 AA

(57) ABSTRACT

A simplified and improved clutch piston, retractor system is provided for controlling the running clearance of clutch plate(s) to minimize windage loss and to improve transmission shift quality. This improved shift quality helps improve operator's comfort reduce shock loads on power transmission components, and reduce the energy input to the clutches when changing gears during the acceleration and deceleration of the vehicle. The clutch piston retractor system is self adjusting to accommodate wear to the clutch disks and optimize the shift quality, while compensating for the additional travel distance. Thus, the need to periodically recalibrate the entire system is eliminated.

### FIELD OF THE INVENTION

The present invention relates generally to a transmission clutch system in a moving vehicle, and more importantly to an apparatus for maintaining the optimized running clearance of the clutch plate(s) to minimize windage loss, and to improve transmission shift quality.

### BACKGROUND OF THE INVENTION

Powershift transmission clutches are commonly used in a variety of work vehicles. Powershift transmission clutches generally include a clutch drum (driving or driven member) having an expandable piston operating fluid chamber or piston cavity, a piston axially slidably positioned against the piston-operating piston cavity, a clutch hub (driven member) coaxially disposed in the clutch drum, and a clutch plate pack interposed between the clutch drum and the clutch hub having one end directed to die piston. The clutch plate pack includes first and second groups of plates which are alternately juxtaposed. When the piston cavity is fed with pressurized operating fluid, the piston is forced to press the clutch plate pack thereby to engage the first and second groups of clutch plates and the corresponding clutch drum and hub.

To shift from one forward gear speed ratio to another gear speed ratio, one or more clutches associated with the current speed ratio is disengaged or released (off-going), substantially simultaneously with the engagement of one or more additional and different clutches (on-coming) by introducing fluid into the clutches (also known as clutch fill time) being engaged at the same time fluid is depressurized from the clutches being disengaged. Under this engaged condition, the clutch drum and the clutch hub are united and thus can rotate together. When the pressurized operating fluid is depressurized from the piston cavity, the piston is pushed back, which releases the clutch plate pack thereby to cancel the engagement between the first and second groups of clutch plates.

Under this disengaged condition, the clutch drum and the clutch hub can rotate separately or individually. The amount of time it takes to move the clutch from the disengaged to the engaged position is programmed into the control logic to optimize the shift quality that a vehicle will have. The optimum situation is to begin engaging the oncoming clutch(es) while the off-going clutch(es) are disengaged. Thus, as torque applied, by the off-going clutch(es) decreases, torque applied by the oncoming clutch(es) increases. This overlap of torques minimizes the sudden pressure or spike in the clutch(es) and provides a smoother transition between gears. The difficulty however, lies in the vehicle's ability to properly overlap the torques due to inherent and changeable time delays during clutch engagement and disengagement.

One danger of the shifting process is that of wear or damage to the gears and clutch plates. As one set of clutch plates are disengaged while another set is engaged, slippage tends to occur and the plates become worn. Specifically, if the two are both engaged simultaneously, this can cause serious damage to the transmission as gear teeth break, or extreme wear as the clutches are forced to slip excessively with respect to each other. Alternatively, if neither of the gears break or the clutches slip, simultaneous engagement in two gear ratios can bring the vehicle to a sudden and precipitous stop.

For this reason, the timing and synchronizing of clutch engagement and disengagement is of critical importance when shifting. To accurately coordinate the engagement and disengagement of the clutches, it is necessary to determine the amount of time it takes for the clutches to engage or disengage. One known method is to perform the coordination by a control valve software recalibration process. This recalibration process, which is performed periodically as required, enables the control software to adjust the timing based on changed clutch fill time due to the wear of the clutch plates, which increases the piston travel time to engagement.

Generally, over a period of time, as the thickness of the clutch plates decrease or plates begin to wear, the running clearance tends to increase. Running clearance also known as the disengaging travel distance is essentially the gap between the clutch plates when the system is de-energized. Some running clearance between clutch plates during its de-energized phase is desired to minimize: 1) the rubbing of clutch plates, 2) brake disk wear, and 3) heat generation and inefficiency due to disk drag. In addition, insufficient running clearance increases windage loss mainly due to hydraulic fluid escaping through small gaps between the clutch plates.

Alternatively, too much running clearance is not desirable for the following reasons: 1) delayed time for hydraulic clutch piston to travel for full clutch engagement, thus affecting transmission shift quality; 2) more axial space is required to accommodate parts in worst-case condition (tolerance stackup); and 3) more hydraulic fluid is needed to move the hydraulic clutch piston this additional distance.

For the above reasons, including the ability to optimize transmission shift quality, it has been the desire of the industry to control the total running clearance of a clutch-plate pack, particularly after the clutch assembly has been in service, and clutch plates have worn due to usage. It is therefore highly desirable to have a clutch piston retractor system that could automatically maintain an “ideal” running clearance regardless of how long the system has been in service. This would enable the designer to optimize the transmission shift quality without having to periodically recalibrate the control as is required in most of today's powershift transmissions.

### SUMMARY OF THE INVENTION

The present invention provides a simplified and improved clutch piston retractor system for controlling the running clearance of clutch plate(s) to minimize windage loss and to improve transmission shift quality. This improved shift quality is desirable to improve operator's comfort, reduce shock loads on power transmission components, and to reduce the energy input to the clutches when changing gears during the acceleration and deceleration of the vehicle. Usually, high loads on the clutches can result in the clutch disks slipping with respect to each other, even when the clutch is engaged. The clutch piston retractor system solves this problem by self adjusting itself to accommodate for the wear to the disks and optimizing the shift quality, while compensating for the additional travel distance. Thus, the need to periodically recalibrate the entire system is eliminated.

### BRIEF DESCRIPTION OF THE DRAWINGS

Several embodiments of the invention are described in greater detail in the following drawings,

FIG. 1 is a side perspective view showing a powershift transmission clutch system in a de-energized mode;

FIG. 2 is a side view of showing the powershift transmission clutch, system of FIG. 1 in an energized mode;

FIG. 3 is a side perspective view showing the powershift transmission clutch system of FIG. 1 in a de-energized mode with clutch piston in an adjusted position;

FIG. 4 is a side perspective view showing an alternative embodiment of a clutch piston retractor system in a de-energized mode;

FIG. 5 is a side perspective view showing an alternative embodiment of a clutch piston retractor system in an energized mode.

### DESCRIPTION OF THE PREFERRED EMBODIMENT

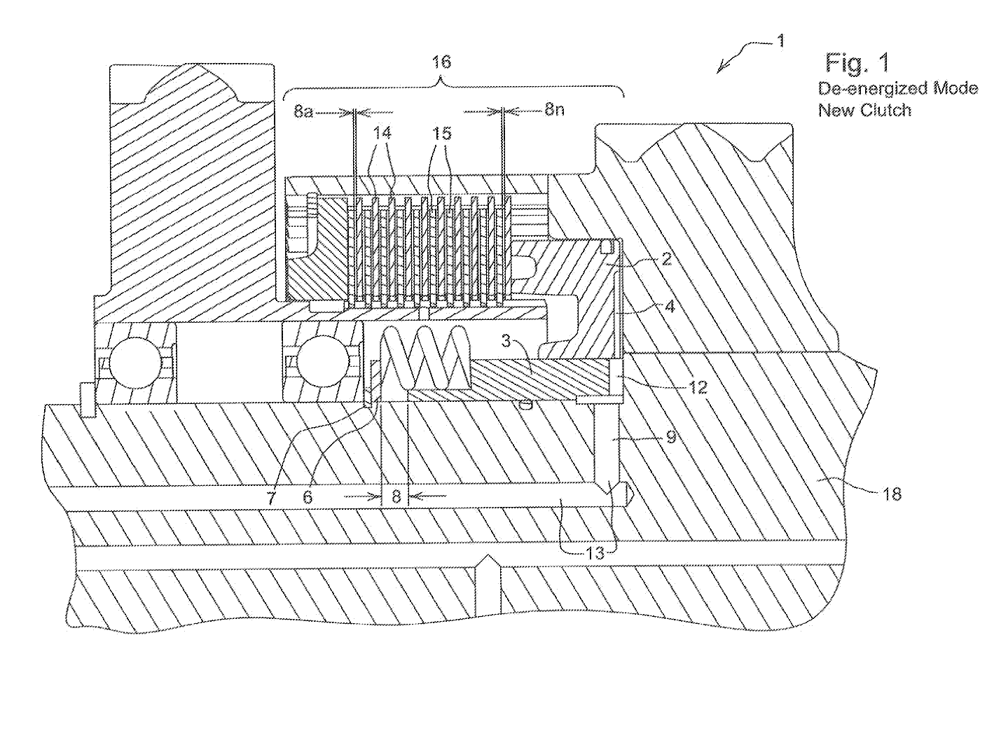

Reference is made first to FIG. 1, which shows an embodiment of the invention using a simple clutch piston retractor system comprised of a hydraulic clutch piston 2, and a sleeve 3 which is press-fitted onto the bore of the hydraulic clutch piston 2, to automatically adjust and position the sleeve 3 to control the clutch running clearance 8 to a pre-determined amount, regardless of how much wear clutch separator plates 14 and friction plates 15 have accumulated.

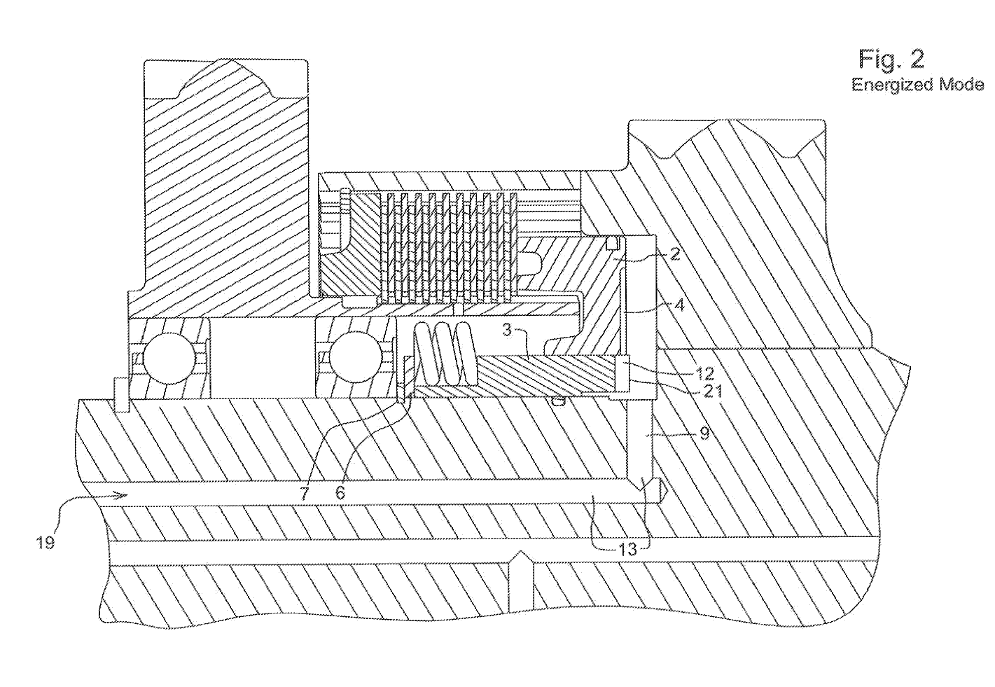

Within the clutch housing 16 is a sleeve 3 that is press fitted onto the bore of the hydraulic clutch piston 2 and both are configured to move together during normal operation, and slip relative to each other to make adjustment for maintaining optimized total running clearance 8. Where total running clearance 8 is the sum of individual running clearance 8a through 8n between separator plates 14 and friction plates 15. When clutch 1 is energized, FIG. 2, the pressurized hydraulic fluid 13 or clutch lube pressure 13 from control valve 19 travels through a lube passage 9 on the clutch shaft 18 and thru slot 12 in sleeve 3 into the piston cavity 4 behind the hydraulic clutch piston 2. As the hydraulic clutch piston 2 is pushed axially within the piston cavity 4 by the hydraulic fluid an axial force is applied to clutch separator and friction plates 14, 15 pressing clutch separator and friction plates 14, 15 together and thus enabling clutch separator and friction plates 14, 15 to become frictionally engaged with each other. The sleeve 3, on the other hand, which is press fitted to the hydraulic clutch piston 2, will move with hydraulic clutch piston 2 and is stopped by retainer 6 and snap ring 7. Since the hydraulic force of the pressurized hydraulic fluid 13 is higher than the friction between sleeve 3 and hydraulic clutch piston 2, the hydraulic clutch piston 2 will slip on sleeve 3 and continue to move to take up the remaining clearance between the clutch, separator and friction plates 14, 15 in order to fully engage clutch 1. The longer it takes the hydraulic clutch piston 2 to travel to fully engage clutch, separator and friction plates 14, 15, the more slippage will occur. This is evident because the hydraulic clutch piston 2 is attached to sleeve 3 and sleeve 3 will only travel a certain distance before it is stopped, by retainer 6. If sleeve 3 reaches the retainer 6 before clutch separator and friction plates 14, 15 are fully engaged, the hydraulic clutch piston 2 will have to continue its travel or travel beyond the point where sleeve 3 has stopped.

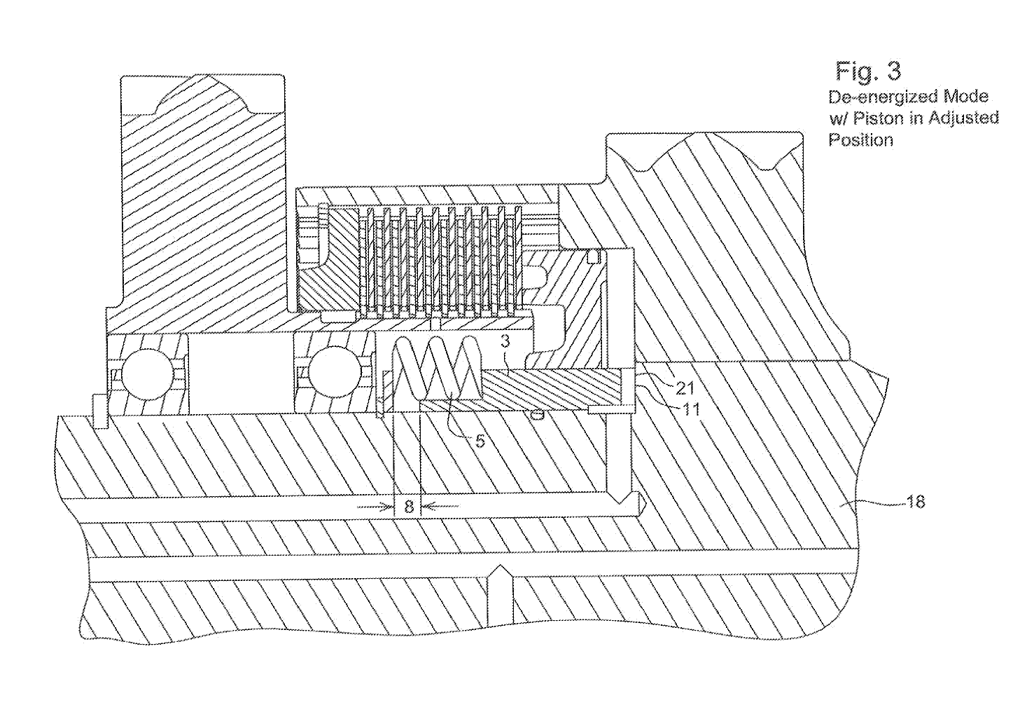

When clutch 1 is de-energized, FIG. 3, spring 5 presses against sleeve 3 in an opposite axial direction until end 21 of sleeve 3 is pushed, back against clutch hub surface 11 and the predetermined running clearance 8 or predetermined travel distance is again readied. Since the hydraulic clutch piston 2 and sleeve 3 are press fitted together, and slippage has occurred between the two, the sleeve 3 will travel back to clutch hub surface 11 while piston 2 will retract back to its final slippage position and not back to the clutch huh surface 11 (i.e. original position). By providing a piston retraction system, the piston 2 will self-adjust no matter how much slippage will occur. Once this slippage occurs, and clutch separator and friction plates 14, 15 decreases in width, the total clutch running clearance 8 will always be the same, and hence the travel distance of clutch piston 2 will always be the same. On the other hand, sleeve 3 will continue to axially adjust its position relative to hydraulic clutch piston 2 and within clutch cavity housing 4 to maintain the predetermined clearance between clutch plates. Without this self adjusted piston on sleeve feature to maintain the predetermined running clearance 8, the need to recalibrate the clutch system would be evident.

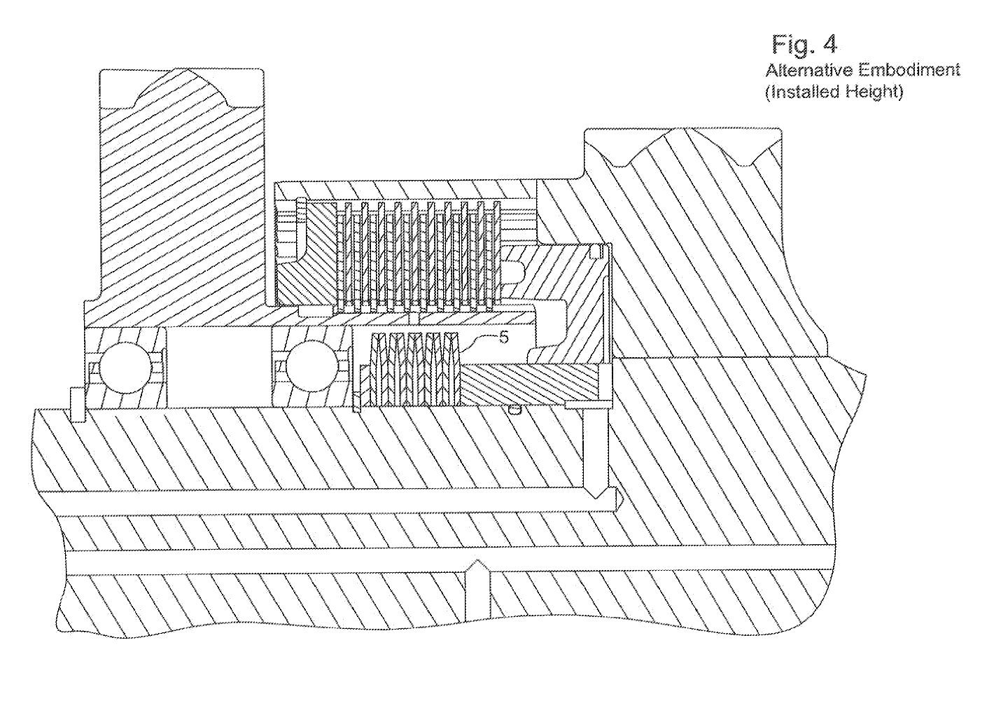

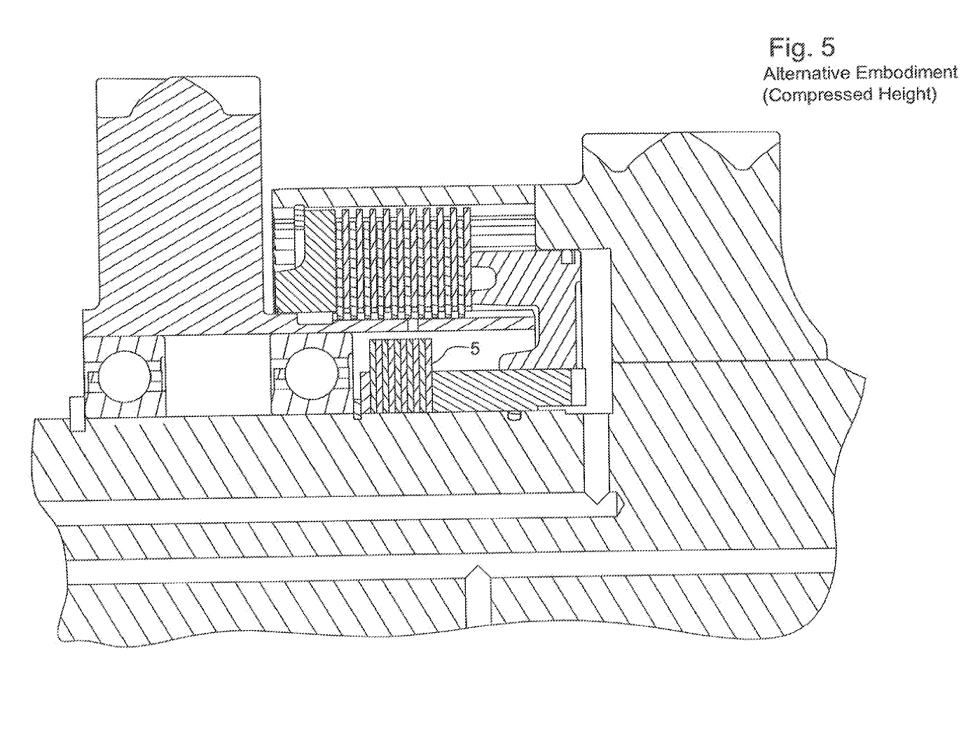

In an alternative embodiment, the difference between spring's installed height FIG. 4 and solid height FIG. 5 within the clutch housing will operate as the predetermined clutch running clearance. Specifically, when the spring system 5, which is comprised of at least one spring, is compressed and formed into one solid piece, the difference between this compressed height and installed height is the predetermined running clearance 8. The piston retractor system will operate in the same manner as described above with the primary difference being the use of the compressed spring as a basis for which the total travel distance will be determined.

Having described the preferred embodiment, it will become apparent that various modifications can be made without departing from the scope of the invention as defined in the accompanying claims.

1. A powershift transmission clutch system for a hydraulically operated clutch having an energized and a de-energized position comprising:
a clutch housing having a piston cavity;
a hydraulic clutch piston disposed within the piston cavity and sliding axially within the piston cavity to engage a series of clutch separator and friction plates coaxially disposed within the piston cavity;
a pressurized hydraulic fluid providing a force within the piston cavity that pushes the hydraulic clutch piston axially;
a clutch drum welded to the clutch housing and having a cylindrical body and splined teeth for engaging the series of clutch separator and friction plates;
a clutch hub surface coaxially disposed within the clutch drum and having the cylindrical body and splined teeth for engaging the series of clutch separator and friction plates;
a clutch plate pack operatively interposed between the clutch drum and the clutch hub surface and engaging the series of clutch separator and friction plates;
a retainer held within the clutch housing;
a sleeve press-fitted onto the hydraulic clutch piston to adjust and position the piston to control a predetermined clutch running clearance amount, the clutch hub surface preventing axial movement of the sleeve if the clutch is de-energized and the retainer acting as a stop to limit travel distance of the sleeve if the clutch is energized;
a spring operatively interposed between the retainer and the clutch hub surface urging the sleeve and piston towards the clutch, hub surface if the clutch is de-energized.

2. The powershift transmission clutch system of claim 1 wherein when the series of clutch separator and friction plates become worn, the distance between the series of clutch separator and friction plates increases and the travel time required for full clutch separator and friction plate engagement increases.

3. The powershift transmission clutch system of claim 1 wherein when the series of clutch separator and friction plates decrease in size from their original thickness to a thickness after wear, the predetermined running clearance is constant.

4. The powershift transmission clutch system of claim 1 wherein a self-adjusting slippage occurs between the sleeve and the hydraulic clutch piston.

5. The powershift transmission clutch system of claim 4 wherein the self-adjusting slippage between the sleeve and clutch piston enables the clutch system to maintain a pre-determined hydraulic clutch piston travel distance.

6. The powershift transmission clutch system of claim 1 wherein the predetermined clutch running clearance maintains the hydraulic clutch piston travel distance at a constant when the hydraulic clutch piston travels axially within the piston cavity to engage the series of clutch separator and friction plates.

7. The powershift transmission clutch system of claim 1 wherein a gap exists between the series of clutch separator and friction plates when they operate in the de-energized position.

8. The powershift transmission clutch system of claim 1 wherein if the clutch is in a de-energized position the spring pushes the sleeve and the hydraulic clutch piston axially towards the hub surface until the sleeve is stopped by the hub surface.

9. The powershift transmission clutch system of claim 1 wherein the force of the pressurized hydraulic fluid causes the hydraulic clutch piston to slip on the sleeve and move axially within the piston cavity to take up clearance between the series of clutch separator and friction plates.

10. The powershift transmission clutch system of claim 1 wherein the force on the hydraulic clutch piston from the pressurized hydraulic fluid is higher than the friction between the sleeve and clutch piston.

11. The powershift transmission clutch system of claim 1 wherein the retainer functions as a stop and slippage between the piston and sleeve occurs after the sleeve engages the stop and during the piston's travel toward the series of clutch separator and friction plates.

12. The powershift transmission clutch system of claim 1 wherein the sleeve returns back to the hub surface after the hydraulically operated clutch is in a de-energized position.

13. A piston retractor system comprising:
a clutch housing having a hydraulic clutch piston, a series of clutch separator and friction plates, a pressurized hydraulic fluid disposed within a piston cavity, a clutch drum, a clutch hub surface, a clutch plate pack, a retainer and a spring system;
the hydraulic clutch piston disposed, within the piston cavity and sliding axially within the piston cavity to engage a series of clutch separator and friction plates coaxially disposed within the piston cavity and decrease running clearance between the series of clutch separator and friction plates;
the pressurized hydraulic fluid maintained within the piston cavity providing a force that pushes the clutch piston axially within the piston cavity;
the clutch drum welded to the clutch housing and having a cylindrical body and splined teeth for engaging the series of clutch separator and friction plates;
the clutch hub surface coaxially disposed within the clutch drum and having the cylindrical body and splined teeth for engaging the series of clutch separator and friction plates;
the clutch plate pack operatively interposed between the clutch drum and the clutch hub surface and engaging the series of clutch separator and friction plates;
the retainer held within the clutch housing;
the spring system, further comprised of at least one spring, operatively interposed between the retainer and the sleeve and having a compressed height and an installed height wherein the difference between the compressed height and installed height provides a predetermined clutch running clearance.

14. The piston retractor system of claim 13 wherein at the compressed height the spring system is rigid.

15. The piston retractor system of claim 13 wherein a total travel distance of the hydraulic clutch piston is axially limited by the compressed height of spring system.
